(19) United States
(12) Patent Application Publication
(10) Pub. No.: US 2026/0139734 A1
(43) Pub. Date: May 21, 2026

(54) OFF-ROAD VEHICLE

(71) Applicant: KAWASAKI MOTORS, LTD., Akashi-shi (JP)

(72) Inventors: Shoya YAMAMOTO, Akashi-shi (JP); Yuuto OGAWA, Akashi-shi (JP)

(73) Assignee: KAWASAKI MOTORS, LTD., Akashi-shi (JP)

(21) Appl. No.: 19/389,021

(22) Filed: Nov. 14, 2025

(30) Foreign Application Priority Data
Nov. 21, 2024 (JP) 2024-203373

(51) Int. Cl. F16H 57/035; B60K 13/04; B62D 63/04; F16H 7/02; F16H 57/02; F16H 57/027; F16H 57/04

(52) U.S. Cl. CPC F16H 57/035; B60K 13/04; F16H 7/02; F16H 57/027; F16H 57/0416; F16H 57/0489; B62D 63/04; F16H 2057/02026; F16H 2057/02056

(57) ABSTRACT

A utility vehicle includes a belt transmission mechanism that includes a CVT input shaft, a drive pulley provided on the CVT input shaft, a CVT output shaft, a driven pulley provided on the CVT output shaft, and a belt transmission body wound around the drive pulley and the driven pulley, in which a driving force input to the CVT input shaft changes a transmission ratio, and is output from the CVT output shaft, a housing body that houses the belt transmission mechanism, a temperature sensor that is located on an inside relative to the housing body in a vehicle width direction and downward relative to an upper end portion of the housing body, and detects a temperature in the housing body.

### CROSS-REFERENCE TO RELATED APPLICATION

This application claims priority to Japanese Patent Application No. 2024-203373, filed on Nov. 21, 2024, the entire contents of which are incorporated herein by reference.

### BACKGROUND OF THE INVENTION

### Technical Field

The present invention relates to an off-road vehicle.

### Related Art

US 2021/0231211 A discloses a utility vehicle. In this utility vehicle, a temperature sensor is provided to measure the temperature of a space in a housing.

### SUMMARY

When an abnormality occurs in the sensor that monitors a state in the housing, this can affect the driving operation performed by a driver or the control performed by a control device.

An object of the present disclosure is to provide an off-road vehicle capable of reducing an abnormality of a sensor that monitors a state in a housing.

The present disclosure provides a utility vehicle including:
a belt transmission mechanism that includes an input shaft, a drive pulley provided on the input shaft, an output shaft, a driven pulley provided on the output shaft, and a belt transmission body wound around the drive pulley and the driven pulley, in which a driving force input to the input shaft is output from the output shaft while changing a transmission ratio;
a housing body that houses the belt transmission mechanism; and
a temperature sensor that is located on an inside relative to an upper end portion of the housing body in a vehicle width direction and downward relative to the upper end portion of the housing body, and detects a temperature in the housing body.

With the utility vehicle according to the present disclosure, the housing is disposed on the outside of the temperature sensor in the vehicle width direction. That is, at least a part of the temperature sensor is covered with the housing from the outside in the vehicle width direction. Thus, collision of foreign matter coming from the outside in the vehicle width direction with the temperature sensor is prevented by the housing. In this manner, the protection effect against the foreign matter coming from the outside of the sensor is enhanced, whereby it is possible to prevent detection abnormalities of the sensor caused by the collision of the foreign matter.

### BRIEF DESCRIPTION OF THE DRAWINGS

FIG. 1 is a left side view of a rear portion of a utility vehicle according to an embodiment of the present disclosure;

FIG. 2 is a plan view illustrating an area around a prime mover of the utility vehicle in FIG. 1;

FIG. 3 is a side view around the prime mover in FIG. 2, as viewed from the inside in the vehicle width direction; and

FIG. 4 is a rear view around the prime mover in FIG. 2, as viewed from the rear.

### DETAILED DESCRIPTION OF EMBODIMENTS

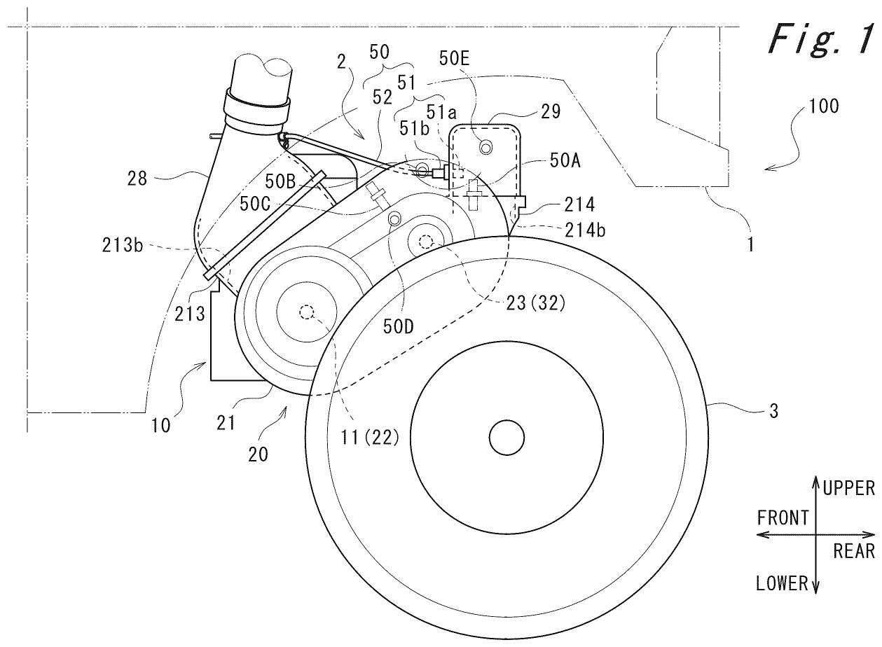

A vehicle according to an embodiment of the present disclosure will be described with reference to FIGS. 1 to 4. The vehicle according to the present embodiment is an off-road vehicle capable of traveling on rough terrain. In the present embodiment, the off-road vehicle is embodied as a utility vehicle 100. The utility vehicle 100 is an example of the off-road vehicle. The off-road vehicle may be embodied also as, for example, an all-terrain vehicle (ATV), a sport recreational vehicle (SRV), a recreational utility vehicle (RUV), a rough terrain vehicle, a saddle-ride vehicle, and a motorcycle. The utility vehicle may be a work vehicle that can carry loads and travel on rough terrain. For example, the utility vehicle may include a cargo bed, a roll-over protective structure (ROPS) that surrounds a riding space, and low air pressure tires for traveling on a rough road, and may further include a side-by-side structure that allows a driver and a passenger to ride side by side. In the following description, a front-rear direction, a left-right direction, and an up-down direction as viewed from the driver are defined as a front-rear direction, a left-right direction, and an up-down direction of the utility vehicle 100 and each component.

FIG. 1 is a left side view around a rear portion of the utility vehicle 100. As illustrated in FIG. 1, the utility vehicle 100 includes a vehicle body 1, and a prime mover unit 2 mounted on the vehicle body 1. In FIG. 1, the vehicle body 1 is indicated by a two-dot chain line, and the prime mover unit 2 is indicated by a solid line. A pair of left and right rear wheels 3 is arranged on both side portions in the rear of the vehicle body 1. The prime mover unit 2 is disposed in the rear of the vehicle body 1.

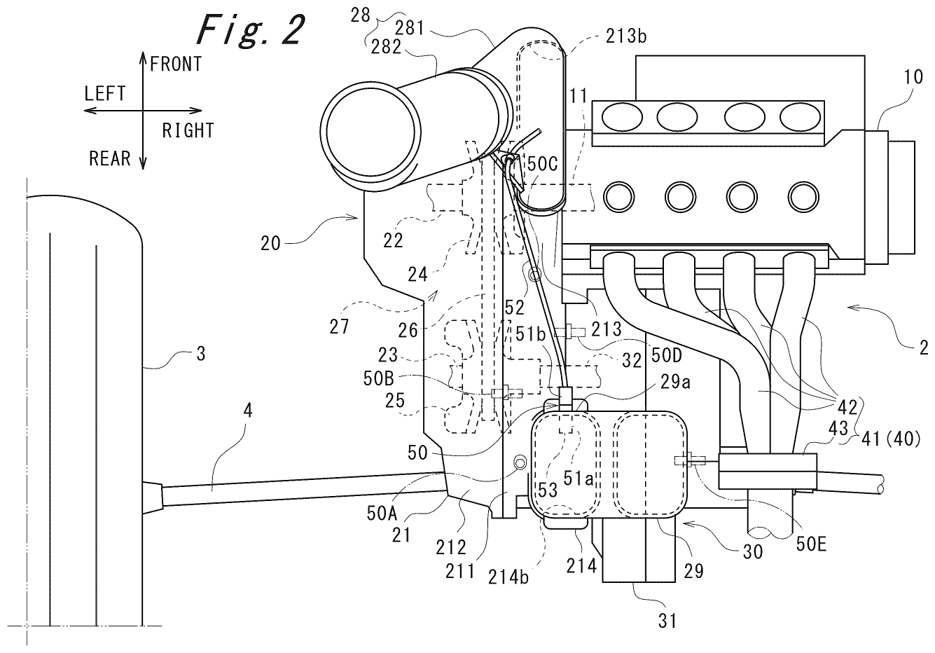

FIG. 2 is a plan view illustrating an area around the prime mover unit 2, in which the vehicle body 1 is omitted. As illustrated in FIG. 2, the prime mover unit 2 includes an engine 10, a continuously variable transmission (CVT) 20, and a secondary transmission 30. In the utility vehicle 100, the drive force output from the engine 10 is transmitted to the rear wheel 3 while a transmission ratio is changed by the CVT 20 and the secondary transmission 30. That is, the rear wheels 3 are drive wheels.

The engine 10 includes a crankshaft 11 to which rotational torque is output. In the present embodiment, the engine 10 is an inline-four engine in which the crankshaft 11 extends in the vehicle width direction. The utility vehicle 100 may include an electric motor in place of the engine 10.

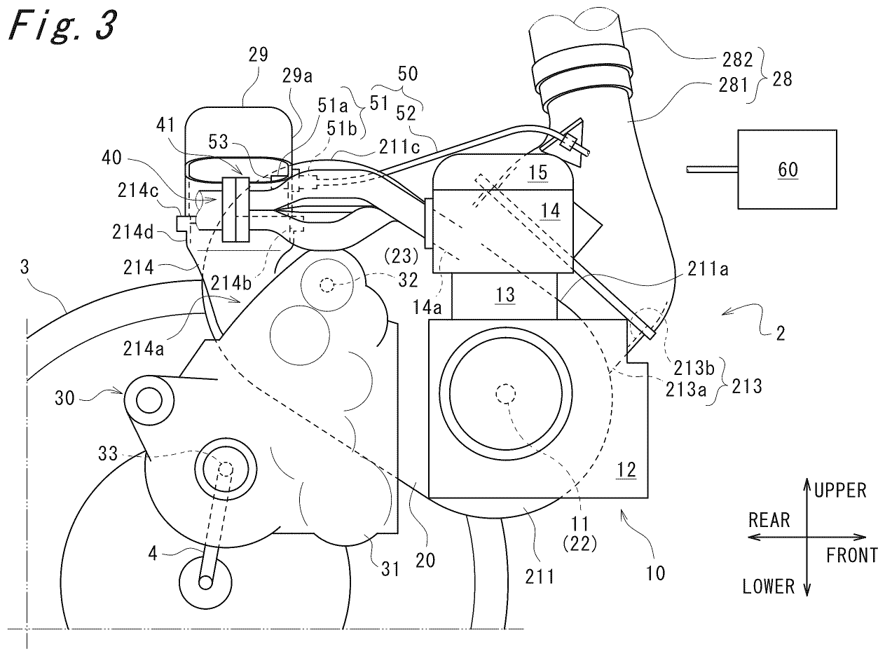

FIG. 3 is a side view around the prime mover unit 2 in FIG. 2, as viewed from the inside in the vehicle width direction. As illustrated in FIG. 3, the engine 10 includes a crankcase 12, a cylinder 13, a cylinder head 14, and a cylinder head cover 15 in this order from below. The crankcase 12 rotatably supports the crankshaft 11. The cylinder 13 is coupled to an upper surface of the crankcase 12. The cylinder head 14 is coupled to an upper surface of the cylinder 13. The cylinder head cover 15 is fixed to an upper surface of the cylinder head 14.

An exhaust system 40 extending rearwardly is connected to a rear surface of the cylinder head 14. The exhaust system 40 includes an exhaust manifold 41. Exhaust gas is discharged from the engine 10 through the exhaust manifold 41. Referring to FIG. 2 together, in the present embodiment, four independent exhaust pipes 42 each connected to an exhaust port 14a of the cylinder head 14 are assembled into one at an outlet flange 43, in the exhaust manifold 41.

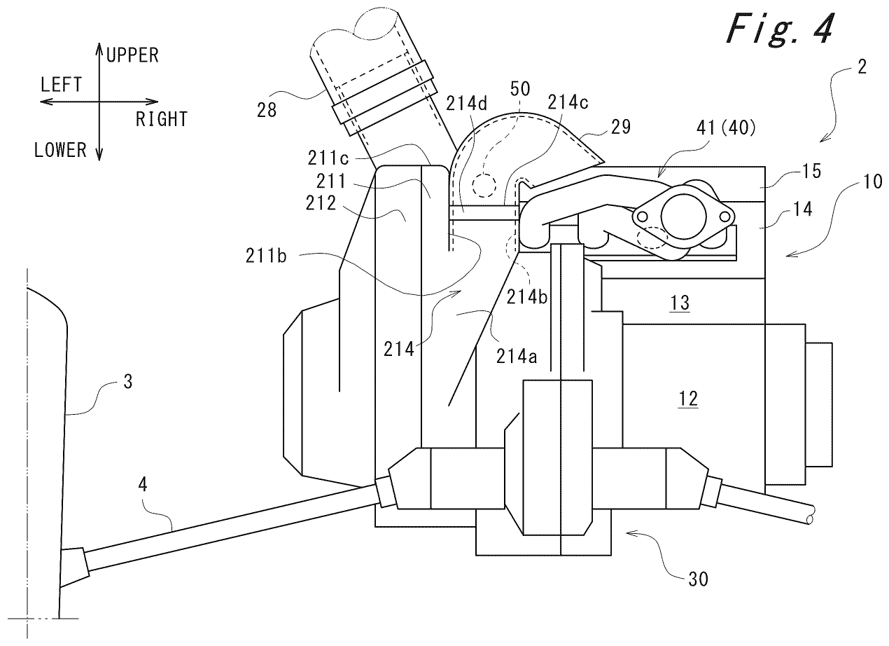

FIG. 4 is a rear view around the prime mover unit 2 in FIG. 2, as viewed from the rear. Referring to FIG. 4 together, the exhaust manifold 41 is located upward relative to the secondary transmission 30, and extends rearwardly at approximately the same height position as those of the cylinder head 14 and the cylinder head cover 15 in the up-down direction.

As illustrated in FIG. 2, the CVT 20 is disposed adjacently to the left side of the engine 10. The CVT 20 includes a CVT housing 21 that forms an outer casing of the CVT 20, and a belt transmission mechanism 27 housed inside the CVT housing 21. The belt transmission mechanism 27 includes a CVT input shaft 22, a CVT output shaft 23, a drive pulley 24, a driven pulley 25, and a belt transmission body 26.

The CVT input shaft 22 extends in the vehicle width direction, and is coupled to the crankshaft 11 so as to be able to transmit power. As illustrated in FIG. 1, the CVT output shaft 23 extends in the vehicle width direction and is positioned rearward and upward relative to the CVT input shaft 22. The CVT housing 21 extends, in side view, in a direction inclined upwardly toward the rear side.

As illustrated in FIG. 2, the drive pulley 24 is disposed on the CVT input shaft 22 so as to rotate integrally with the CVT input shaft 22. The driven pulley 25 is disposed on the CVT output shaft 23 so as to rotate integrally with the CVT output shaft 23. The belt transmission body 26 is wound around the drive pulley 24 and the driven pulley 25. In the CVT 20, the drive rotation input from the crankshaft 11 is transmitted to the CVT input shaft 22 to change a transmission ratio via the drive pulley 24, the belt transmission body 26, and the driven pulley 25, and is output from the CVT output shaft 23 to the secondary transmission 30.

The CVT housing 21 includes a housing body 211 that opens to an outside in the vehicle width direction, a housing cover 212 that covers the housing body 211 from the outside in the vehicle width direction, and a CVT intake port 213 and a CVT exhaust port 214 that are integrally formed with the housing body 211. External air is taken into the inside of the CVT housing 21 through the CVT intake port 213. Air inside the CVT housing 21 is discharged to the outside through the CVT exhaust port 214. In this manner, the air in the CVT housing 21 is exchanged through the CVT intake port 213 and the CVT exhaust port 214, whereby a temperature rise of the belt transmission body 26 is reduced.

The CVT housing 21 is exposed toward the outside of the vehicle, and is disposed while being opposed particularly to the left rear wheel 3 from the inside in the vehicle width direction. The CVT housing 21 is disposed around the rear wheel 3. Specifically, as illustrated in FIG. 1, at least a part of the CVT housing 21 overlaps the rear wheel 3 in vehicle side view. More specifically, a rear end of the CVT housing 21 is located forward relative to a rear end of the rear wheel 3 and upward relative to an upper end of the rear wheel 3. Further, as illustrated in FIG. 2, the CVT housing 21, in top view, is disposed at an interval on the inside in the vehicle width direction relative to the rear wheel 4. That is, the CVT housing 21 is disposed in a position in which foreign matters, such as sand, stones, and mud, kicked up from a road surface by the rear wheel 3, can interfere.

In the CVT housing 21, the housing body 211 and the housing cover 212 are coupled in the vehicle width direction such that their opening portions are closed to each other, thereby preventing entry of foreign matter and air coming from components other than the CVT intake port 213 and the CVT exhaust port 214. The housing body 211 includes an upper end portion 211c at an outside end in the vehicle width direction. In the housing body 211, among an upper surface thereof, an inside portion positioned inwardly in the vehicle width direction relative to the coupling portion coupled to the housing cover 212, is located downward relative to the upper end portion 211c of the housing body 211.

As illustrated in FIG. 3, the CVT intake port 213 protrudes in a direction inclined upwardly approximately from the front half of an upper wall 211a of the housing body 211 toward the front side. A base end portion 213a of the CVT intake port 213 faces approximately the CVT input shaft 22 and the drive pulley 24. The CVT intake port 213 has a CVT intake opening 213b at a distal end portion. The CVT intake opening 213b is elongated in the front-rear direction, and opens in a direction inclined upwardly toward the front side. A CVT intake duct 28 is connected to the CVT intake opening 213b.

The CVT intake duct 28 is divided into two parts including a first intake duct 281 connected to the CVT intake opening 213b and a second intake duct 282 connected to a distal end of the first intake duct 281. The sectional shape of the first intake duct 281 changes from a base end portion elongated in the front-rear direction to a cylindrical distal end portion. The second intake duct 282 is a cylindrical pipe member and extends upwardly. An air cleaner that removes foreign matter from the air taken into the CVT housing, may be provided at a distal end portion of the second intake duct 282. The CVT intake duct 28 has an upper end located upward relative to the CVT housing 21.

The CVT exhaust port 214 protrudes inwardly in the vehicle width direction from a side wall 211b (see FIG. 4) on the inside in the vehicle width direction and extends upwardly, in an upper portion on the rear side of the housing body 211. A base end portion 214a of the CVT exhaust port 214 faces approximately rearward of the CVT output shaft 23 and the driven pulley 25. The CVT exhaust port 214 has a CVT exhaust opening 214b at a distal end portion. The CVT exhaust opening 214b is elongated in the front-rear direction and opens upwardly. A CVT exhaust duct 29 is connected to the CVT exhaust opening 214b.

When viewed from the inside in the vehicle width direction, the CVT exhaust port 214 extends clockwise from a position of the housing body 211 corresponding to a rear portion of the CVT output shaft 23 in the rotation direction of the CVT output shaft 23 and the driven pulley 25. In the CVT exhaust port 214, an upper end portion 214c is expanded in the front-rear direction downward relative to the upper end portion 211c of the housing body 211, and a rear portion 214d protrudes rearward relative to the housing body 211.

As illustrated in FIG. 4, the CVT exhaust duct 29 extends upwardly and curves rightwardly, and a distal end portion extends in a direction inclined downwardly toward the right side. The CVT exhaust duct 29 has a flat front side surface 29a that extends in parallel to the up-down direction and the vehicle width direction at a front side portion, with the sectional shape orthogonal to the extending direction being elongated at the front-rear direction. The CVT exhaust duct 29 is located on the inside relative to the housing body 211 in the vehicle width direction. In the CVT exhaust duct 29, an upper end is located upward relative to the CVT housing 21. The CVT exhaust duct 29 has an inside end in the vehicle width direction which is located on the inside in the vehicle width direction relative to an inside end of the CVT housing 21 in the vehicle width direction. Since the CVT exhaust duct 29 extends in an inverted U-shape inwardly in the vehicle width direction from the CVT exhaust port 214, the inside end of the CVT exhaust duct 29 in the vehicle width direction is away from the CVT housing 21 toward the inside in the vehicle width direction. A lower end of the CVT exhaust duct 29 is located downward relative to an upper end of the CVT housing 21.

The belt transmission body 26 may be made of a non-metallic material, for example, may be made of resin. The temperature of the belt transmission body 26 may rise due to, for example, frictional heat during power transmission between the drive pulley 24 and the driven pulley 25. The temperature of the belt transmission body 26 is particularly likely to rise in a power transmission state at high load during rotation at high speed. When the belt transmission body 26 is made of resin, continuous power transmission in a high temperature state may result in shortening the service life or lessening the belt strength.

The CVT 20 enables switching to a transmission ratio at which the load to be transmitted is increased. In the utility vehicle 100 traveling on rough terrain, the power transmission in the CVT 20 can be brought into a higher load state as the load of the cargo bed and the number of passengers increase. Further, particularly when traveling on rough terrain, the utility vehicle 100 sometimes continues and repeats a power transmission state in a high load state in order to climb over an obstacle or climb a hill. As described above, the utility vehicle 100 is more likely to be brought into a traveling state under a high load, as compared with vehicles traveling on a paved road. Thus, the temperature of the belt transmission body 26 easily rises.

As illustrated in FIG. 3, in the present embodiment, the CVT exhaust duct 29 is located at a position rearward of the housing body 211. Specifically, the CVT exhaust duct 29 is located rearward relative to the CVT output shaft 23. With this arrangement, it is easy to widely secure an area covered by the housing body 211 from the outside in the vehicle width direction, in an area located forward relative to the CVT exhaust duct 29.

The CVT 20 is of an air-cooled type that takes air from the CVT intake opening 213b into the inside of the CVT housing 21 via the CVT intake duct 28, and cools the inside of the CVT housing 21, i.e., the belt transmission mechanism 27 by the taken air. The air having cooled the inside of the CVT housing 21 is then discharged from the CVT exhaust opening 214b to the outside of the CVT housing 21 via the CVT exhaust duct 29. For example, fins may be provided in the back of the drive pulley 24 to form a centrifugal fan in which air is taken in from the CVT intake opening 213b by the fins with the rotation of the drive pulley 24.

As illustrated in FIG. 2, the secondary transmission 30 is disposed rearward relative to the engine 10 and adjacently to the right side of the CVT 20. The secondary transmission 30 includes a transmission housing 31 that forms an outer casing, as well as a transmission input shaft 32, a transmission output shaft 33 (see FIG. 3), and a gear train (not illustrated) that are housed inside the transmission housing 31.

As illustrated in FIG. 3, the transmission input shaft 32 extends at an upper front portion of the transmission housing 31 in the vehicle width direction, and is coupled to the CVT output shaft 23 so as to be able to transmit power. That is, the transmission input shaft 32 is located upward and rearward relative to the crankshaft 11. The transmission output shaft 33 extends at a lower rear portion of the transmission housing 31 in the vehicle width direction. That is, the transmission output shaft 33 is located downward and rearward relative to the transmission input shaft 32. In the secondary transmission 30, the drive rotation input from the CVT output shaft 23 is transmitted to the transmission input shaft 32 while changing a transmission ratio with the gear train (not illustrated), and is output from the transmission output shaft 33.

A drive shaft 4 for driving the rear wheels 3 is connected to the transmission output shaft 33. The transmission housing 31 has an upper portion inclined downwardly toward the rear side.

In the utility vehicle 100 according to the present disclosure, the CVT 20 includes a state monitoring sensor that detects or monitors a state in the CVT housing 21. As described above, the service life of the belt transmission body 26 may be shortened when the temperature thereof becomes high due to, for example, frictional heat during power transmission between the drive pulley 24 and the driven pulley 25. Hence, in the present embodiment, the CVT 20 includes a temperature sensor 50, serving as the state monitoring sensor, that detects the temperature in the CVT housing 21. In the present embodiment, the temperature sensor 50 is attached to the front side surface 29a of the CVT exhaust duct 29. As illustrated in FIG. 1, in vehicle side view, the temperature sensor 50 is disposed upward relative to the rear wheel 3, and in the present embodiment, upward relative to the upper end of the rear wheel 3.

The temperature sensor 50 includes a sensor body portion 51 that extends in the front-rear direction, and a sensor harness portion 52 that is connected to a front end portion (base end portion) of the sensor body portion 51 and extends forwardly.

The sensor body portion 51 extends in the front-rear direction and extends through the front side surface 29a of the CVT exhaust duct 29 in the front-rear direction. Since the sensor body portion 51 extends in the front-rear direction, its extending direction follows the extending direction of the sensor harness portion 52, and bending of the sensor harness portion 52 is restrained from being increased. Further, the extending direction of the sensor body portion 51 follows the front-rear direction in which the CVT housing 21 extends. Therefore, if the amount of protrusion of the sensor body portion 51 from the front side surface 29a is large, an increase in the size of the CVT housing 21 to cover the temperature sensor 50 is restrained. In addition, since the sensor body portion 51 extends in the front-rear direction, it is easy to make the CVT compact in the vehicle width direction.

The sensor body portion 51 includes a sensor-body first portion 51a that is located inside the CVT exhaust duct 29, i.e., in a space to be detected, and a sensor-body second portion 51b that is located outside the space to be detected. The sensor-body first portion 51a includes a detector 53 at a rear end portion (distal end portion). The sensor-body second portion 51b is located between the CVT intake duct 28 and the CVT exhaust duct 29 in the front-rear direction.

The detector 53 is located inside the CVT exhaust duct 29, and detects the temperature in the space inside the CVT exhaust duct 29. In the present embodiment, since the detector 53 is located inside the CVT exhaust duct 29, it is easy to detect an elevated exhaust air temperature by cooling each component in the CVT housing 21. Thus, it is easy to estimate the temperature of the belt transmission body 26 based on the temperature detected by the detector 53.

The sensor harness portion 52 is located forward relative to the sensor body portion 51 while extending forwardly from the sensor body portion 51, being clamped on the right side surface of the CVT intake duct 28, extending further forwardly, and being electrically connected to an ECU 60 for controlling the operations of the engine 10, the CVT 20, and the secondary transmission 30.

The ECU 60 may control the operation of the engine 10 based on a detection result from the temperature sensor 50. For example, when it is determined that the temperature in the CVT housing 21, i.e., the temperature of the belt transmission body 26 exceeds a predetermined threshold value based on a detection result from the temperature sensor 50, the output of the engine 10 may be lowered or the engine speed may be lowered to reduce the driving force transmitted to the CVT 20. As a result, the temperature of the belt transmission body 26 can be restrained from becoming excessively high. This allows damage to the belt transmission body 26 to be reduced.

When the temperature in the CVT housing 21 exceeds a predetermined threshold value, the ECU 60 may cause a meter unit that displays a speed and the like to display a warning. This warning facilitates the driving operation to lower the temperature of the belt transmission body 26 by the driver. For example, when noticing the displayed warning, the driver is able to reduce the engine output or lower the engine speed.

Furthermore, the ECU 60 may receive a signal from the temperature sensor 50 together with the operating state of the engine 10 to estimate a replacement timing of the belt transmission body 26. When determining that the belt transmission body 26 reaches the replacement timing, the ECU 60 may cause the meter unit to display information for prompting the replacement of the belt transmission body 26. For example, the ECU 60 may perform calculation to accelerate the replacement timing of the belt transmission body 26 as the operating state continues in a deterioration advancing state in which the temperature in the CVT housing 21 exceeds a predetermined threshold value. A detection result of the temperature sensor 50 is transmitted to the driver or the ECU 60 in this manner; however, a method of using a detection result other than the above method may be adopted.

A specific arrangement of the temperature sensor 50 will be described. As illustrated in FIG. 4, the temperature sensor 50 is located, in the vehicle width direction, on the inside relative to the CVT housing 21, specifically, the upper end portion 211c of the housing body 211 and downward relative to the upper end portion 211c of the housing body 211. As illustrated in FIG. 3, in vehicle side view, the sensor-body second portion 51b of the temperature sensor 50 is covered with the housing body 211 of the CVT 20 from the outside in the vehicle width direction. In other words, in vehicle side view, the sensor-body second portion 51b overlaps the housing body 211. Note that a portion of the sensor harness portion 52 connected to the sensor-body second portion 51b also overlaps the housing body 211 in vehicle side view. Thus, a portion of the sensor harness portion 52 connected to the sensor-body second portion 51b as well as the sensor-body second portion 51b is protected by the housing body 211 from the outside in the vehicle width direction.

As illustrated in FIG. 2, the temperature sensor 50 is located on the opposite side to the left rear wheel 3 with respect to the housing body 211. The temperature sensor 50 is located upward relative to the secondary transmission 30. Specifically, at least a part of the temperature sensor 50 overlaps the transmission housing 31 in vehicle plan view.

Further, the temperature sensor 50 is covered with the exhaust system 40, in the present embodiment, the exhaust manifold 41 from the inside in the vehicle width direction. In other words, the exhaust system 40 is located on the opposite side to the housing body 211 of the CVT 20 in the vehicle width direction with respect to the temperature sensor 50, and overlaps with the temperature sensor 50 in vehicle side view illustrated in FIG. 3. The temperature sensor 50 may be covered, from the inside in the vehicle width direction, with another member included in the exhaust system 40, or another member, such as a cover covering the exhaust system, in place of the exhaust manifold 41.

In the present embodiment, the temperature sensor 50 is attached to the CVT exhaust duct 29. The temperature sensor 50 may be attached to the CVT intake duct 28 as long as it is covered with the housing body 211 from the outside in the vehicle width direction. Alternatively, the temperature sensor 50 may be attached to the CVT intake port 213 or the CVT exhaust port 214 so as to be covered with the housing body 211 from the outside in the vehicle width direction.

The utility vehicle 100 according to the present disclosure has the following effects.
(1) A utility vehicle 100 includes:
a belt transmission mechanism 27 that includes a CVT input shaft 22, a drive pulley 24 provided on the CVT input shaft 22, a CVT output shaft 23, a driven pulley 25 provided on the CVT output shaft 23, and a belt transmission body 26 wound around the drive pulley 24 and the driven pulley 25, in which a driving force input to the CVT input shaft 22 is output from the CVT output shaft 23 while changing a transmission ratio;
a housing body 211 that houses the belt transmission mechanism 27; and
a temperature sensor 50 that is located on an inside relative to an upper end portion 211c of the housing body 211 in a vehicle width direction and downward relative to the upper end portion 211c of the housing body 211, and detects a temperature in the housing body 211.

With this configuration, the housing body 211 is disposed on the outside of the temperature sensor 50 in the vehicle width direction. At least a part of the temperature sensor 50 is covered with the housing body 211 from the outside in the vehicle width direction. Collision of foreign matter coming from the outside in the vehicle width direction with the temperature sensor 50 is prevented by the housing body 211. Thus, it is possible to prevent an abnormality of the temperature sensor 50 caused by the collision of foreign matter with the temperature sensor 50. Further, prevention of an abnormality of the temperature sensor 50 can be embodied by utilizing the CVT housing 21 without providing a dedicated cover that covers the temperature sensor 50, or the like, so that it is possible to restrain an increase in cost.
(2) The temperature sensor 50 may be attached to the housing body 211 or a CVT exhaust duct 29.

With this configuration, when a housing cover 212 is removed from the housing body 211 in order to replace the belt transmission body 26, the necessity of removing the temperature sensor 50 is eliminated, and thus, it is possible to facilitate the replacement work of the belt transmission body 26, as compared with a case that the temperature sensor 50 is attached to the housing cover 212.
(3) The temperature sensor 50 includes a sensor body portion 51, and a sensor harness portion 52 connected to the sensor body portion 51,
the sensor body portion 51 includes a sensor-body first portion 51a located in a space to be detected, and a sensor-body second portion 51b located outside the space to be detected and to which the sensor harness portion 52 is connected, and
in vehicle side view, the sensor-body second portion 51b overlaps the housing body 211. In other words, the sensor-body second portion 51b is located on the inside relative to the housing cover 212 in the vehicle width direction.

With this configuration, an outside portion of the housing body 211 in the vehicle width direction and the housing cover 212 are located on the outside relative to the sensor-body second portion 51b in the vehicle width direction, so that it is possible to prevent collision of an obstacle and an operator with the sensor-body second portion 51b. In this manner, the sensor-body second portion 51b protruding from the CVT housing 21 and easily damaged can be protected, and the sensor abnormality can be more easily prevented.
(4) The housing body 211 has a CVT intake opening 213b and a CVT exhaust opening 214b that communicate with an inside and an outside,
the utility vehicle 100 further includes a CVT intake duct 28 and the CVT exhaust duct 29 respectively attached to the CVT intake opening 213b and the CVT exhaust opening 214b, and
the temperature sensor 50 is attached to the CVT exhaust duct 29 or the CVT intake duct 28.

With this configuration, the temperature sensor 50 is easily disposed on the inside in the vehicle width direction, as compared with a case that the temperature sensor 50 is attached to the housing body 211. Further, a fixing structure for fixing the temperature sensor 50 is easily formed when the CVT intake duct 28 or the CVT exhaust duct 29 is smaller than the housing body 211.
(5) The temperature sensor 50 is attached to a front side surface 29a of the CVT exhaust duct 29.

With this configuration, the outside of the temperature sensor 50 in the vehicle width direction is protected by the housing body 211, and a rear side is protected by the CVT exhaust duct 29. This makes it possible to prevent foreign matter moving in a front-rear direction from colliding with the temperature sensor 50. Note that the CVT housing 21 is disposed forward relative to a rear side surface of the duct provided in the CVT housing 21, specifically, relative to a rear side surface of the CVT exhaust duct 29, whereby it is possible to protect the CVT housing 21 by the rear side surface of the CVT exhaust duct 29. Further, the CVT housing 21 is disposed rearward relative to a front side surface of the duct provided in the CVT housing 21, specifically, relative to a front side surface of the CVT intake duct 28, whereby it is possible to protect the CVT housing 21 by the front side surface of the CVT intake duct 28.
(6) The utility vehicle 100 further includes a rear wheel 3, and
the temperature sensor 50 is located on an opposite side to the rear wheel 3 with respect to the housing body 211.

With this configuration, the housing body 211 is located between the temperature sensor 50 and the rear wheel 3. Collision of foreign matter kicked up by the rear wheel 3 with the temperature sensor 50 is prevented by the housing body 211.
(7) The CVT exhaust duct 29 has, on at least a part thereof, a front side surface 29a that is a flat surface to which the temperature sensor 50 is fixed.

With this configuration, the temperature sensor 50 is easily fixed to the front side surface 29a that is a flat surface, as compared with a case that the temperature sensor 50 is fixed to a spherical surface.
(8) The CVT exhaust opening 214b is an opening through which air in the housing body 211 is discharged to the outside, and
the CVT exhaust duct 29 is attached to the CVT exhaust opening 214b.

With this configuration, it is possible to detect an exhaust air temperature that can become high, by cooling an inner side of the housing body 211, the exhaust air temperature being elevated and discharged from the housing body 211, which facilitates estimation of the temperature inside the housing body 211.
(9) The CVT exhaust opening 214b is located downward relative to the upper end portion 211c of the housing body 211.

With this configuration, since a base end portion of the CVT exhaust duct 29 is disposed downward relative to the housing body 211, the temperature sensor 50 is easily protected by the CVT exhaust duct 29 and the housing body 211.
(10) In vehicle side view, at least a part of the CVT exhaust opening 214b overlaps the housing body 211.
(11) The utility vehicle 100 further includes:
the CVT intake duct 28 that is attached to the housing body 211 and supplies outside air to an inside of the housing body 211; and
the CVT exhaust duct 29 that is attached to the housing body 211 and discharges inside air to an outside of the housing body 211, and
the temperature sensor 50 is located between the CVT exhaust duct 29 and the CVT intake duct 28 in the front-rear direction.

With this configuration, collision of foreign matter flying from the front-rear direction with the temperature sensor 50 is prevented by the CVT intake duct 28 and the CVT exhaust duct 29.
(12) The utility vehicle 100 further includes:
a crankshaft 11 or a transmission input shaft 32 that is connected to the CVT input shaft 22 or the CVT output shaft 23; and
a crankcase 12 or a transmission housing 31 that houses the crankshaft 11 or the transmission input shaft 32, and is located on the inside relative to the housing body 211 in the vehicle width direction, and
the temperature sensor 50 is located upward relative to the crankcase 12 or the transmission housing 31, and, in vehicle top view, overlaps the crankcase 12 or the transmission housing 31.

With this configuration, collision of foreign matter flying from below with the temperature sensor 50 is prevented by the crankcase 12 or the transmission housing 31.
(13) The utility vehicle 100 further includes:
the transmission input shaft 32 connected to the CVT output shaft 23; and
the transmission housing 31 that houses the transmission input shaft 32, and is located on the inside relative to the housing body 211 in the vehicle width direction, and
the temperature sensor 50 is located upward relative to the transmission housing 31, and overlaps the transmission housing 31 in vehicle top view.

With this configuration, collision of foreign matter flying from below with the temperature sensor 50 is prevented by the transmission housing 31 to which the CVT output shaft 23 is connected.
(14) The utility vehicle 100 further includes a shielding member that is located on an opposite side to the housing body 211 in the vehicle width direction with respect to the temperature sensor 50, overlaps with the temperature sensor 50 in vehicle side view, and covers the temperature sensor 50 from the opposite side.

With this configuration, collision of foreign matter flying from the opposite side to the housing body 211 in the vehicle width direction with the temperature sensor 50 is prevented by the shielding member.
(15) The utility vehicle 100 further includes:
an engine 10; and
an exhaust system 40 through which exhaust gas is discharged from the engine 10, and
in vehicle plan view, the temperature sensor 50 is located between the housing body 211 and the exhaust system 40 in the vehicle width direction.

With this configuration, collision of foreign matter flying from the vehicle width direction with the temperature sensor 50 is prevented by the housing body 211 and the exhaust system 40.

The utility vehicle 100 according to the present disclosure is not limited to the configuration of the above-described embodiment, and various modifications can be made.

In the present embodiment, the temperature sensor 50 is provided as a sensor that monitors the state in the CVT housing 21; however, any other sensor, for example, a rotation sensor that detects the rotational speed of the driven pulley 25 may be provided. In this case as well, the sensor is configured to be covered with the housing body 211 from the vehicle with direction, whereby it is possible to prevent collision of external foreign matter with the sensor.

Alternatively, for example, a different sensor, from the above described sensor, for detecting the degree of damage of the belt transmission body 26 may be used. The state monitoring sensor may be a sensor that detects the temperature of the belt transmission body 26, or may be sensors that detect the temperature of the housing body 211 or the housing cover 212 itself, and the temperature of a rotating body in the CVT housing 21. The state monitoring sensor may also be sensors that detect the pressure in the CVT housing 21, and the flow rates and flow velocities of air passing through the CVT intake port 213 and the CVT exhaust port 214. Alternatively, the state monitoring sensor may be a sensor for acquiring a position of the belt transmission body 26, a state image of the belt transmission body 26, driving sound of the belt transmission body 26, or the like. The state monitoring sensor may be a sensor that detects foreign matter, such as dust and rainwater having entered the CVT housing 21. Further, the state monitoring sensor is not limited to the sensor that detects the degree of damage to the belt transmission body 26, and may be a sensor used for other purposes. For example, the rotational speed of a rotating body in the CVT housing 21 may be detected, or an axial position of a member in the CVT housing 21 may be detected.

In the present embodiment, the temperature sensor 50 is provided upward with respect to the transmission housing 31, but may be provided upward with respect to a different member. For example, the temperature sensor 50 may be provided to be located upward with respect to the engine 10. In this case as well, it is possible to prevent collision of foreign matter coming from below with the temperature sensor 50 by the engine 10.

That is, the utility vehicle 100 according to the present disclosure further includes:
the belt transmission body 26 that transmits a driving force from the engine 10;
the housing body 211 that houses the belt transmission body 26; and
the state monitoring sensor that detects a state in the housing body 211, at least a part of the state monitoring sensor being covered with the housing body 211 in vehicle side view.

With this configuration, the housing body 211 is disposed on an outside of the state monitoring sensor in the vehicle width direction. At least the part of the state monitoring sensor is covered with the housing body 211 from the outside in the vehicle width direction. Collision of foreign matter coming from the outside in the vehicle with direction with the state monitoring sensor is prevented by the housing body 211.

In the present embodiment, the temperature sensor 50 is provided inside the housing body 211 of the CVT 20, but may be provided inside the housing cover 212. In this case, it suffices to configure the temperature sensor 50 or the state monitoring sensor to be covered with the housing cover 212 from the outside in the vehicle width direction.

That is, the utility vehicle 100 according to the present disclosure includes:
the belt transmission body 26 that transmits a driving force from the engine 10;
the housing body 211;
the housing cover 212 that is attached to the housing body 211, and defines, in cooperation with the housing body 211, a belt chamber housing the belt transmission body 26; and
the state monitoring sensor that detects the state in the housing body 211, and is located on the inside relative to the housing cover 212 in the vehicle width direction.

With this configuration, the housing cover 212 is disposed on the outside of the state monitoring sensor in the vehicle width direction. At least a part of the state monitoring sensor is covered with the housing cover 212 from the outside in the vehicle width direction. Collision of foreign matter coming from the outside in the vehicle width direction with the state monitoring sensor is prevented by the housing cover 212.

In the present embodiment, the temperature sensor 50 is attached to the front side surface 29a of the CVT exhaust duct 29. However, when the CVT exhaust duct 29 is provided on the front side of the CVT output shaft 23, and an area covered from the outside in the vehicle width direction by the CVT housing 21 is allowed to be widely secured rearward with respect to the CVT exhaust duct 29, then, the temperature sensor may be attached to a rear side surface 29b of the CVT exhaust duct 29. This also makes it possible to easily cover and protect the temperature sensor 50 by the housing body 211 from the outside in the vehicle width direction. Moreover, the front side of the temperature sensor 50 is protected by the CVT exhaust duct 29. Furthermore, the temperature sensor 50 may be attached to the front side surface or the rear side surface of the CVT intake duct 28. In this case, when the rear side or the front side of the temperature sensor 50 is protected by the CVT intake duct 28, and when the temperature sensor 50 is covered with the CVT housing 21 from the outside in the vehicle width direction, then, the temperature sensor 50 is protected by the CVT housing 21 from the outside in the vehicle width direction.

The following cases are also conceivable as arrangement examples of the state monitoring sensor.

As another arrangement example of the sensor 50, as illustrated in FIGS. 1 and 2, a sensor 50A may be fixed to the housing body 211, and attached at a position on the upper surface extending in the vehicle width direction while located on the inside relative to the upper end portion 211c in the vehicle width direction and one step downward relative to the upper end portion 211c. In this case, the sensor 50A is located between the CVT exhaust duct 29 and the housing cover 212.

As still another arrangement example of the sensor 50, as illustrated in FIGS. 1 and 2, a sensor 50B may be fixed to the housing body 211, and attached at a position on the side surface extending in the up-down direction while located on the inside relative to the upper end portion 211c in the vehicle width direction and one step downward relative to the upper end portion 211c.

As still another arrangement example of the sensor 50, as illustrated in FIGS. 1 and 2, a sensor 50C may be fixed to the housing body 211, and attached at a position on the upper surface extending in the front-rear direction while located on the inside relative to the upper end portion 211c in the vehicle width direction and one step downward relative to the upper end portion 211c. In this case, the sensor 50C is located forward relative to the CVT exhaust duct 29.

As still another arrangement example of the sensor 50, as illustrated in FIGS. 1 and 2, a sensor 50D may be fixed to the housing body 211, and attached at a position on the side surface extending in the up-down direction while located on the inside of the housing body 211 in the vehicle width direction.

As still another arrangement example of the sensor 50, as illustrated in FIGS. 1 and 2, a sensor 50E may be fixed to the CVT exhaust duct 29, and attached at a position on the side surface extending in the up-down direction while located inside of the CVT exhaust duct 29 in the vehicle width direction.

The number of passengers of the utility vehicle 100 is not limited. The utility vehicle 100 may have a single row seat or front and rear two-row seats. Further, an off-road vehicle to which the present embodiment is applied is not limited to a side-by-side vehicle, and is also applicable to a saddle-ride three-wheeled or four-wheeled buggy vehicle including a belt transmission mechanism.

The positions of the CVT intake duct 28 and the CVT exhaust duct 29 may be interchanged. In this case as well, the sensor 50 is preferably disposed closer to the CVT exhaust duct 29 than the CVT intake duct 28.

In addition to the engine 10, an electric motor may also be provided as a drive source. The secondary transmission 30 may be omitted. The present embodiment may be applied to other vehicles as long as the vehicle includes a housing in which the belt transmission body 26 is housed. The structure according to the present disclosure can be more suitably applied to the belt transmission body 26 housed in the housing in a CVT that offers a variable transmission ratio. The belt transmission body 26 housed in the housing may be a power transmission belt with which the transmission ratio is fixed to one.

In the above embodiment, the case that one CVT intake duct 28 and one CVT exhaust duct 29 are provided in the CVT housing 21, has been described taking as an example; however, the present disclosure is not limited thereto. The present disclosure may also be applied to a case that the CVT housing 21 is provided with a plurality of, e.g., two, CVT intake ducts 28, and a plurality of, e.g., two, CVT exhaust ducts 29. In this case, the temperature sensor 50 may be attached to at least any one of the plurality of CVT intake ducts 28 and the plurality of CVT exhaust ducts 29. In this case as well, it is preferable that the temperature sensor 50 be attached in the front-rear direction between any one of the plurality of CVT intake ducts 28 and the plurality of CVT exhaust ducts 29 that are arranged in the front-rear direction. When the temperature sensor 50 is attached to the plurality of CVT exhaust ducts 29, the temperature sensor 50 may be attached to any one of the CVT exhaust ducts 29, or the temperature sensors 50 may be attached to two or more of the plurality of CVT exhaust ducts 29.

What is claimed is:

1. An off-road vehicle comprising:
a belt transmission mechanism that includes an input shaft, a drive pulley provided on the input shaft, an output shaft, a driven pulley provided on the output shaft, and a belt transmission body wound around the drive pulley and the driven pulley, in which a driving force input to the input shaft is output from the output shaft while changing a transmission ratio;
a housing body that houses the belt transmission mechanism; and
a temperature sensor that is located on an inside relative to an upper end portion of the housing body in a vehicle width direction and downward relative to the upper end portion of the housing body, and detects a temperature in the housing body.

2. The off-road vehicle according to claim 1, wherein
the temperature sensor includes a sensor body portion, and a sensor harness portion connected to the sensor body portion,
the sensor body portion includes a sensor-body first portion located in a space to be detected, and a sensor-body second portion located outside the space to be detected and to which the sensor harness portion is connected, and
in vehicle side view, the sensor-body second portion overlaps the housing body.

3. The off-road vehicle according to claim 1, wherein
the housing body has an opening communicating with an inside and an outside,
the off-road vehicle further comprises a duct attached to the opening, and
the temperature sensor is attached to the duct.

4. The off-road vehicle according to claim 3, wherein the temperature sensor is attached to either a front side surface or a rear side surface of the duct.

5. The off-road vehicle according to claim 3, wherein the duct has, on at least a part, a flat surface to which the temperature sensor is fixed.

6. The off-road vehicle according to claim 3, wherein
the opening is an exhaust port through which air in the housing body is discharged to an outside, and
the duct is an exhaust duct attached to the exhaust port.

7. The off-road vehicle according to claim 3, wherein the opening is located downward relative to the upper end portion of the housing body.

8. The off-road vehicle according to claim 7, wherein, in vehicle side view, at least a part of the opening overlaps the housing body.

9. The off-road vehicle according to claim 1, further comprising a wheel, wherein
the temperature sensor is located on an opposite side to the wheel with respect to the housing body.

10. The off-road vehicle according to claim 1, further comprising:
an intake duct that is attached to the housing body and supplies outside air to an inside of the housing body; and
an exhaust duct that is attached to the housing body and discharges inside air to an outside of the housing body, and
the temperature sensor is located between the exhaust duct and the intake duct in the front-rear direction.

11. The off-road vehicle according to claim 1, further comprising:
a transmission member connected to the input shaft or the output shaft; and
a transmission member case that houses the transmission member, and is located on an inside relative to the housing body in the vehicle width direction, wherein
the temperature sensor is located upward relative to the transmission member case, and overlaps the transmission member case in vehicle top view.

12. The off-road vehicle according to claim 1, further comprising:
a transmission member connected to the output shaft; and
a transmission member case that houses the transmission member, and is located on an inside relative to the housing body in the vehicle width direction, wherein
the temperature sensor is located upward relative to the transmission member case, and overlaps the transmission member case in vehicle top view.

13. The off-road vehicle according to claim 1, further comprising a shielding member that is located on an opposite side to the housing body in the vehicle width direction with respect to the temperature sensor, overlaps with the temperature sensor in vehicle side view, and covers the temperature sensor from the opposite side.

14. The off-road vehicle according to claim 1, further comprising:
an internal combustion engine; and
an exhaust system through which exhaust gas is discharged from the internal combustion engine, wherein
in vehicle plan view, the temperature sensor is located between the housing body and the exhaust system in the vehicle width direction.

15. An off-road vehicle comprising:
a belt transmission body that transmits a driving force from a drive source;
a housing body that houses the belt transmission body; and
a state monitoring sensor that detects a state in the housing body, at least a part of the state monitoring sensor being covered with the housing body in vehicle side view.

16. An off-road vehicle comprising:
a belt transmission body that transmits a driving force from a drive source;
a housing body;
a housing cover that is attached to the housing body, and defines, in cooperation with the housing body, a belt chamber housing the belt transmission body; and
a state monitoring sensor that detects a state in the housing body, and is located on an inside relative to the housing cover in a vehicle width direction.
